(19) United States
(12) Patent Application Publication
(10) Pub. No.: US 2016/0142663 A1
(43) Pub. Date: May 19, 2016

(54) Battery, battery charger, battery ports, battery packs for televisons

(71) Applicant: Patricia Ann Jackson, Perris, CA (US)

(72) Inventor: Patricia Ann Jackson, Perris, CA (US)

(21) Appl. No.: 14/544,037

(22) Filed: Nov. 19, 2014

(51) Int. Cl. H04N 5/63

(52) U.S. Cl. CPC H04N 5/63

(57) ABSTRACT

My invention transforms the traditional television into a battery operated television set, making wall mounting easier allowing the TV to be placed on any desired wall without having to worry about exposed power cords. This invention will replace, or it can be used as an alternative to the traditionally manufactured TV.

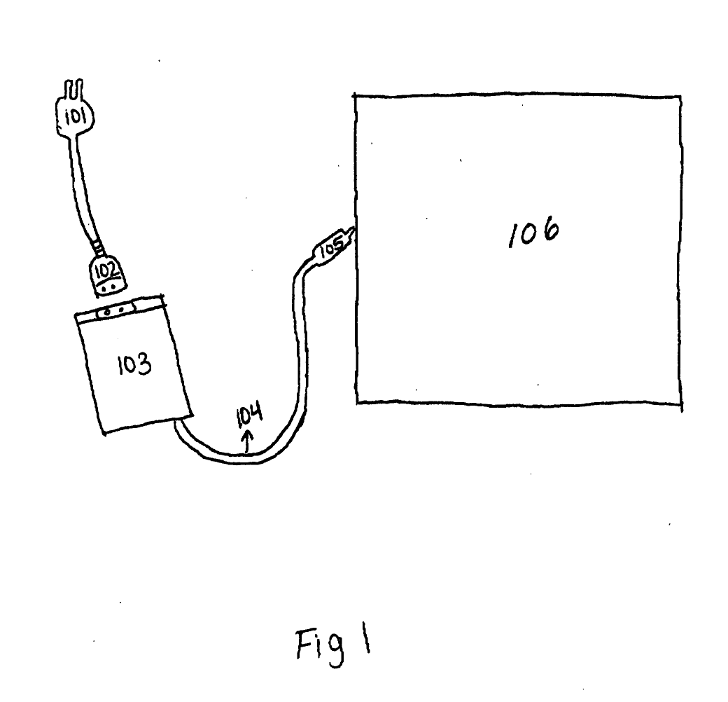

### CROSS REFERENCE

U.S. 62/070,532

### SPECIFICATIONS

This patent application is filed to protect and introduce the ideas and the manufacturing concept of battery operated televisions, and to safeguard these concepts from any unauthorized use or alterations.

### DETAILED DESCRIPTION

This patent will require that flat screen televisions be manufactured with a battery inside of the TV unit. This battery can be recharged by a power cord being inserted into a port on the side or in the back of the unit, and the other end of cord can be plugged into an electrical wall outlet to charge the battery. Once the TV is recharged the cord can be removed from the TV and unplugged from the wall, making the TV wireless. The TV will be constructed with an indicator devise inside of the TV unit that would indicate when the battery is low and needed to be charged. The indicator showing when the battery needed to be charged will be visible on the TV screen. The TV could be recharged at night while the owner is sleeping or at any time that the battery is low and in need of a charge. This patent will change the way that flat screen TVs are mounted on walls. This idea makes, hanging a flat screen TV as easy as hanging a picture on the wall, and the TV can be changed from wall to wall whenever you like.

### BACKGROUND

This idea was conceived out of a desire to eliminate the unsightly scene of an electrical cord hanging from a flat screen TV mounted on the wall. Or a cord camouflaged by a metal or plastic covering to hide the cord.

1-7. (canceled)

8. A combination of a battery pack system and a television, comprising:
the television having an interior area and a back surface;
the battery pack system being disposed within the interior area, the system having:
an electric port secured to the back surface of the television;
a plurality of rechargeable batteries conductively coupled to the electric port; and
a detachable power cord removably secured to the electric port;
wherein the rechargeable batteries are charged via electrical energy traveling through the power cord and through the electric port.

9. The combination of claim 8, further comprising:
an indicator device secured to the television and operably associated with the battery pack system;
wherein the indicator device is configured to provide indication when the rechargeable batteries are low.

10. The combination of claim 9, wherein the indicator device is shown on a display of the television.
